(19) United States
(12) Patent Application Publication
(10) Pub. No.: US 2017/0040639 A1
(43) Pub. Date: Feb. 9, 2017

(54) ELECTROLYTE AND LITHIUM-ION BATTERY COMPRISING SAID ELECTROLYTE

(71) Applicant: NingDe Contemporary Amperex Technology Limited, NingDe City (CN)

(72) Inventors: Kefei WANG, NingDe City (CN); Changlong HAN, NingDe City (CN); Chenghua FU, NingDe City (CN)

(21) Appl. No.: 15/184,807

(22) Filed: Jun. 16, 2016

(30) Foreign Application Priority Data
Aug. 6, 2015 (CN) 201510477524.4

(51) Int. Cl. H01M 10/0567; H01M 10/0569; H01M 10/0568; H01M 10/0525

(52) U.S. Cl. CPC H01M 10/0567; H01M 10/0525; H01M 10/0569; H01M 10/0568; H01M 2300/0025

(57) ABSTRACT

The present disclosure relates to an electrolyte and a lithium-ion battery comprising said electrolyte. The electrolyte includes an organic solvent, a lithium salt, vinylene carbonate, fluoroethylene carbonate, and a combined additive. The combined additive includes: propane sultone at 0.1% to 7% of the total weight of the electrolyte, ethylene sulfate at 0.1% to 7% of the total weight of the electrolyte, and adipic dinitrile at 0.1% to 9% of the total weight of the electrolyte. The use of the electrolyte according to the present disclosure in a lithium-ion battery can greatly improve the initial efficiency, cycle performance, high-temperature storage performance, overcharging endurance performance and safety performance of the lithium-ion battery at a high voltage above 4.4 V.

CROSS-REFERENCE TO RELATED APPLICATION(S)

This application claims the benefit of Chinese Patent Application No. 201510477524.4, entitled “ELECTROLYTE AND LITHIUM-ION BATTERY COMPRISING SAID ELECTROLYTE” and filed on Aug. 6, 2015 in the State Intellectual Property Office of the People's Republic of China (PRC) (SIPO), the disclosure of which is expressly incorporated by reference herein in its entirety.

### BACKGROUND

### Field

The present disclosure relates generally to the field of lithium-ion batteries, and more particularly, to an electrolyte and a lithium-ion battery (LIB) comprising said electrolyte.

### Background

Lithium-ion batteries have remarkable characteristics such as high voltage, high capacity and long service life. More and more researches are being done to expand the market of high-capacity lithium-ion batteries, e.g., for electric automobiles. To meet higher requirements, in-depth studies have been conducted on a number of aspects, including positive electrode materials, negative electrode materials, electrolytes, etc. of lithium-ion batteries. Among those studies, studies on electrode/electrolyte interface properties have attracted particular attention. For example, studies on properties of solid electrolyte interface (SEI) films on the surface of carbon negative electrodes, film formation mechanisms thereof, and surface modification of carbon material.

Studies over recent years have found that an interfacial reaction occurs between a positive electrode material and an electrolyte of a lithium-ion battery. Said interfacial reaction could have a significant impact on electrochemical properties and thermal stability of the positive electrode material, as well as battery safety and other battery properties. As a result, the selection of an excellent film-forming additive has become the key to solve this problem. In particular, the combined use of additives has become a research focus since the combined use of additives has the advantages of individual additives in some aspects and may ameliorate shortcomings of individual additives in other aspects.

According to the literature, when a cyclic carbonate compound containing a C═C double bond, such as vinylene carbonate, is used as an additive, it forms a SEI film on the negative electrode surface, which may improve the C-rate (charge and discharge rates) and cycle life of a lithium-ion battery, but greatly lowers the high-temperature storage performance and low-temperature performance of the lithium-ion battery. Further according to the literature, propane sultone has an excellent film-forming property, which can improve the cycle performance and high-temperature storage performance of a lithium-ion battery, but leads to a poorer low-temperature discharge performance of the lithium-ion battery. In addition, although ethylene sulfate can improve initial efficiency, capacity, low-temperature charge and discharge performance and cycle performance of a battery, ethylene sulfate could result in a poorer high-temperature storage performance of the battery. In particular, ethylene sulfate would significantly lower the cycle performance and storage performance of a lithium-ion battery in a high voltage system.

In more and more traditional technologies, researchers have begun to pay attention to combined use of additives. For example, the combined use of propane sultone and ethylene sulfate forms a solid SEI film on the negative electrode surface, which can adsorb water in the electrode and small molecules decomposed from solvents. However, the safety performance of the combined use of propane sultone and ethylene sulfate cannot be ensured, and the overcharge resistance performance of the combined use of propane sultone and ethylene sulfate is relatively poor. Moreover, with the combined use of propane sultone and ethylene sulfate, the cycle performance and storage performance of a battery will be greatly reduced when the working voltage is increased to above 4.4 V.

With regard to an electrolyte of a lithium-ion battery that combines the use of fluoroethylene carbonate, ethylene carbonate, and cyclic sulfate, the lithium-ion battery that uses said electrolyte will only demonstrate excellent cycle performance and storage performance at below 4.2 V.

In addition, combined additives that contain a sulfonate ester can also be used in an electrolyte of a lithium-ion battery, which can improve the overcharging endurance performance of the lithium-ion battery, reduce the gas production of the battery during charging and discharging processes, and improve low-temperature performance of the battery. If such an electrolyte is used at a high voltage above 4.4 V, however, the lithium-ion battery will demonstrate very poor cycle performance and storage performance.

Although the combined additives described above can ameliorate shortcoming of individual additives in some aspects such that a battery demonstrates better performance in some respect, the combined additives described above still shows relatively poor cycle performance and storage performance in a high voltage system above 4.4 V.

In view of this, there is currently an urgent need for the development of a combined additive to be used in an electrolyte of a lithium-ion battery, which can improve initial efficiency, cycle performance, high-temperature storage performance, low-temperature charge and discharge performance and other comprehensive performance of the lithium-ion battery in a high voltage system.

### SUMMARY

To solve the problems described above, the applicants have conducted research and found an electrolyte that comprises an organic solvent, a lithium salt, vinylene carbonate, fluoroethylene carbonate, and a combined additive, wherein said combined additive comprises propane sultone, ethylene sulfate, and adipic dinitrile. Said electrolyte can improve initial efficiency, cycle performance, high-temperature storage performance, overcharging endurance performance and safety performance of a lithium-ion battery at a high voltage.

The objective of the present disclosure is to provide an electrolyte that comprises an organic solvent, a lithium salt, vinylene carbonate, fluoroethylene carbonate, and a combined additive, wherein said combined additive comprises ingredients at the following percent by weight:

| | |
|---|---|
| propane sultone | 0.1% to 7% of the total weight of the electrolyte; |
| ethylene sulfate | 0.1% to 7% of the total weight of the electrolyte; |
| adipic dinitrile | 0.1% to 9% of the total weight of the electrolyte. |

Another objective of the present disclosure is to provide a lithium-ion battery comprising a positive film, a negative film, a separator for the lithium-ion battery, and the electrolyte according to the present disclosure. Said positive film comprises a positive electrode current collector and a positive electrode active substance layer disposed on the positive electrode current collector. Said positive electrode active substance layer comprises a positive electrode active material, a bonding agent, and a conductive agent. Said negative film comprises a negative electrode current collector and a negative electrode active substance layer disposed on the negative electrode current collector. Said negative electrode active substance layer comprises a negative electrode active material, a bonding agent, and a conductive agent.

The use of the electrolyte according to the present disclosure in a lithium-ion battery can greatly improve initial efficiency, cycle performance, high-temperature storage performance, overcharging endurance performance and safety performance of the lithium-ion battery at a high voltage above 4.4 V.

### BRIEF DESCRIPTION OF THE DRAWINGS

FIG. 1 is a diagram illustrating Table 1 that lists amounts of different materials added for electrolytes in Examples 1 to 18.

FIG. 2 is a diagram illustrating Table 2 that lists amounts of different materials added for electrolytes in Comparison Examples 1 to 7.

FIG. 3 is a diagram illustrating Table 3 that lists electrolytes used in different lithium-ion batteries, as well as measured thickness expansion rate and internal resistance increase rate at 20 d and 35 d, and residual capacity retention rate and restoration capacity ratio at 35 d of each lithium-ion battery.

FIG. 4 is a diagram illustrating Table 4 that lists electrolytes used in different lithium-ion batteries and the test results of initial efficiency and storage performance at 45° C. of each lithium-ion battery.

FIG. 5 is a diagram illustrating Table 5 that lists electrolytes used in different lithium-ion batteries and the test results of overcharging endurance performance of each lithium-ion battery.

FIG. 6 is a diagram illustrating Table 6 that lists electrolytes used in different lithium-ion batteries and the test results of SEI film resistance and charge transfer resistance of each lithium-ion battery.

### DETAILED DESCRIPTION

The present disclosure and the advantageous effects of certain configurations will be further described in detail below with reference to the accompanying drawings and specific embodiments.

The objective of the present disclosure is to provide an electrolyte that comprises an organic solvent, a lithium salt, vinylene carbonate, fluoroethylene carbonate, and a combined additive. Said combined additive may comprise ingredients at the following percent by weight:

| | |
|---|---|
| propane sultone | 0.1% to 7% of the total weight of the electrolyte; |
| ethylene sulfate | 0.1% to 7% of the total weight of the electrolyte; |
| adipic dinitrile | 0.1% to 9% of the total weight of the electrolyte. |

In the above electrolyte, vinylene carbonate is represented by Formula 1 below.

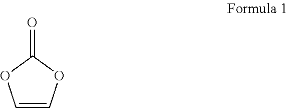

Vinylene carbonate represented by Formula 1 is added as an additive into the electrolyte.

Based on the total weight of the electrolyte, in one aspect, the vinylene carbonate content may be 0.1% to 3% of the total weight of the electrolyte. Furthermore, in one aspect, the vinylene carbonate content may be 0.7% to 2.5% of the total weight of the electrolyte. And yet furthermore, in one aspect, the vinylene carbonate content may be 1% to 2% of the total weight of the electrolyte.

In the electrolyte described above, fluoroethylene carbonate is represented by Formula 2 below.

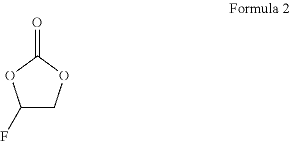

Fluoroethylene carbonate represented by Formula 2 is added as an additive into the electrolyte.

Based on the total weight of the electrolyte, in one aspect, the fluoroethylene carbonate content may be 0.1% to 10% of the total weight of the electrolyte. Furthermore, in one aspect, the fluoroethylene carbonate content may be 1% to 9% of the total weight of the electrolyte. And yet furthermore, in one aspect, the fluoroethylene carbonate content may be 3% to 7% of the total weight of the electrolyte.

In the electrolyte described above, propane sultone is represented by Formula I below.

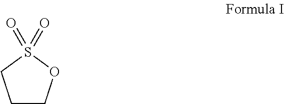

Based on the total weight of the electrolyte, in one aspect, the propane sultone content may be 0.8% to 6.5% of the total weight of the electrolyte. Furthermore, in one aspect, the propane sultone content may be 1.8% to 6% of the total weight of the electrolyte. And yet furthermore, in one aspect, the propane sultone content may be 3% to 5% of the total weight of the electrolyte.

In the electrolyte described above, ethylene sulfate is represented by Formula II below.

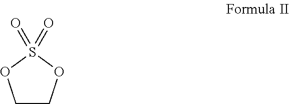

Based on the total weight of the electrolyte, in one aspect, the ethylene sulfate content may be 0.3% to 5.5% of the total weight of the electrolyte. Furthermore, in one aspect, the ethylene sulfate content may be 0.7% to 4.5% of the total weight of the electrolyte. And yet furthermore, in one aspect, the ethylene sulfate content may be 1% to 3% of the total weight of the electrolyte.

In the electrolyte described above, adipic dinitrile is represented by Formula III below.

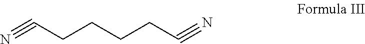

Based on the total weight of the electrolyte, in one aspect, the adipic dinitrile content may be 0.4% to 8.5% of the total weight of the electrolyte. Furthermore, in one aspect, the adipic dinitrile content may be 0.8% to 7.5% of the total weight of the electrolyte. And yet furthermore, in one aspect, the adipic dinitrile content may be 1% to 7% of the total weight of the electrolyte.

When an electrolyte comprises said combined additive, the electrolyte is able to form a film with good compactness, low thickness, good stability and excellent ductility on surfaces of the cathode and anode of a lithium-ion battery. As a result, the use of an electrolyte comprising said combined additive in a lithium-ion battery not only can improve initial efficiency, cycle performance, and high-temperature storage performance of the lithium-ion battery at a high voltage above 4.4 V, but also improves overcharging endurance performance of the lithium-ion battery at a high voltage above 4.4 V and improves safety performance of the lithium-ion battery at a high voltage above 4.4 V.

In the electrolyte described above, there is no particular limitation on specific types of the lithium salt being used, which may be selected according to actual needs.

In one embodiment, the lithium salt may be one or more compounds selected from the group consisting of lithium hexafluoro phosphate, lithium tetrafluoro borate, lithium hexafluoro arsenate, lithium perchlorate, trifluoro sulphonyl lithium, lithium bis(trifluoro methanesulphonyl)imide, lithium bis(fluorosulphonyl)imide and lithium tris(trifluoro methanesulphonyl)methide.

Wherein, there is no particular limitation on the content of the lithium salt in an electrolyte, and the content of the lithium salt in an electrolyte may be selected according to actual situations.

In one aspect, the lithium salt content may be selected such that the molarity of the lithium salt in an electrolyte is 0.7 to 1.3 mol/L. If the molarity of the lithium salt is too low, the conductivity of the electrolyte is low, which then will affect C-rate performance and cycle performance of the lithium-ion battery as a whole. If the molarity of the lithium salt is too high, the viscosity of the electrolyte will consequently be too high, which will similarly affect C-rate performance and cycle performance of the lithium-ion battery as a whole. In a further aspect, the lithium salt content may be selected such that the molarity of the lithium salt in an electrolyte is 0.9 to 1.2 mol/L. In a yet further aspect, the lithium salt content may be selected such that the molarity of the lithium salt in an electrolyte is 1 mol/L.

In the electrolyte described above, there is no particular limitation on specific types of the organic solvent being used, which may be selected according to actual needs.

In one embodiment, the organic solvent may be one or more substances selected from the group consisting of ethylene carbonate (EC), propene carbonate (PC), dimethyl carbonate (DMC), diethyl carbonate (DEC), ethylmethyl carbonate (EMC), y-butyrolactone (BL), methyl formate (MF), ethyl formate (MA), ethyl propionate (EP), and tetrahydrofuran (THF). In particular, the organic solvent may be at least two substances selected from the above substances.

In the present disclosure, there is no particular limitation on preparation methods for electrolytes, which may be prepared using a conventional method, as long as materials in an electrolyte are mixed homogenously. For example, according to the amounts of selected materials to be added, add propane sultone, ethylene sulfate, vinylene carbonate, fluoroethylene carbonate, adipic dinitrile, and a lithium salt into an organic solvent for mixing to obtain an electrolyte. Wherein, there is no particular limitation on the sequence of material addition, and the sequence of material addition may be selected according to actual situations.

Another objective of the present disclosure is to provide a lithium-ion battery, comprising a positive film, a negative film, a separator for the lithium-ion battery, and an electrolyte, wherein the electrolyte is an electrolyte according to the present disclosure.

In the lithium-ion battery described above, the positive film comprises a positive electrode current collector and a positive electrode active substance layer disposed on the positive electrode current collector. Said positive electrode active substance layer comprises a positive electrode active material, a bonding agent, and a conductive agent. Said negative film comprises a negative electrode current collector and a negative electrode active substance layer disposed on the negative electrode current collector. Said negative electrode active substance layer comprises a negative electrode active material, a bonding agent, and a conductive agent. Wherein, specific types of the positive electrode current collector, the positive electrode active material, the negative electrode current collector, the negative electrode active material, the bonding agent, the conductive agent, and the separator for the lithium-ion battery are not subject to any specific limitation, and are all conventional raw materials, which may be selected as needed.

For example, aluminum foil may be selected for the positive electrode current collector; copper foil may be selected for the negative electrode current collector; the bonding agent may be one or more substances selected from the group consisting of polyvinylidene difluoride (PVDF), styrene-butadiene rubber (SBR) and sodium carboxymethyl cellulose (CMC); the conductive agent may be one or more substances selected from the group consisting of superconductive carbon, carbon nanotube, graphene, and carbon nanofiber; the separator for the lithium-ion battery may be selected from the group consisting of polyethylene, polypropylene, polyvinylidene difluoride, and a multi-layer composite film of the above polyethylene, polypropylene, and polyvinylidene difluoride. Specific types of different materials are described above, which, however, do not limit the types of materials for the positive electrode current collector, the negative electrode current collector, the bonding agent, the conductive agent, and the separator for the lithium-ion battery to the specific types of materials listed above.

In one embodiment, the positive electrode active material may be one or more substances selected from the group consisting of LiCoO₂, LiMn₂O₄, and Li(CoₓNi_{y}Mn_{1-x-y})O₂, wherein 0.3≦x≦0.8, 0.1≦y≦0.4, and 0.6≦x+y≦0.9.

In one embodiment, the negative electrode active material may be one or more substances selected from the group consisting of graphite and silicon. The specific types of graphite and silicon may be selected according to actual needs. For example, the graphite and silicon may be one or more of artificial graphite, natural graphite, silicon alloys, silicon oxides, or elemental silicon.

The method for preparing a lithium-ion battery according to the present disclosure is well known in the art, and the lithium-ion battery according to the present disclosure may be prepared using a traditional method for preparing a lithium-ion battery.

Since the lithium-ion battery according to the present disclosure comprises an electrolyte according to the present disclosure, the lithium-ion battery has the following advantageous technical effects:

1. At a high voltage above 4.4 V, initial efficiency has been improved and therefore, it can be seen that the lithium-ion battery achieves a higher energy density;

2. At a high voltage above 4.4 V, cycle performance is good, and capacity retention rate is excellent under charging/discharging conditions;

3. At a high voltage above 4.4 V, high-temperature storage performance is good, changes to thickness and internal resistance are small, and residual capacity and restoration capacity are high;

4. At a high voltage above 4.4 V, overcharging endurance performance is good, and the lithium-ion battery does not catch fire, explode or leak when overcharged.

### EXAMPLES

The present disclosure will be further described below with reference to specific embodiments, but these embodiments are only exemplary and do not limit the scope of the present disclosure in any way.

All reagents, materials and instruments used in the following examples, comparison examples, and experiment examples may be purchased from the market, unless otherwise specifically noted.

Materials used in the following examples, comparison examples and experiment examples are shown below:

Organic solvent: a mixture of dimethyl carbonate (DMC), ethylene carbonate (EC), and propene carbonate (PC), wherein DMC, EC, and PC are added in such amounts that the weight ratio of DMC to EC to PC is DMC: EC: PC=1: 1: 1.

Lithium salt: LiPF6.

Propane sultone (PS), ethylene sulfate (DTD), vinylene carbonate (VC), fluoroethylene carbonate (FEC), adipic dinitrile (ADN).

Separator for the lithium-ion battery: 12 μm thick polypropylene separator (e.g., Model A273 provided by Celgard).

### Examples 1 to 18

Electrolytes 1^{#} to 18^{#} are obtained sequentially in Examples 1 to 18 using the following preparation method:

Add the lithium salt into the organic solvent, then add PS, DTD, ADN, VC, and

FEC, mix homogeneously and obtain an electrolyte, wherein, the molarity of the lithium salt in the electrolyte is 1 mol/L.

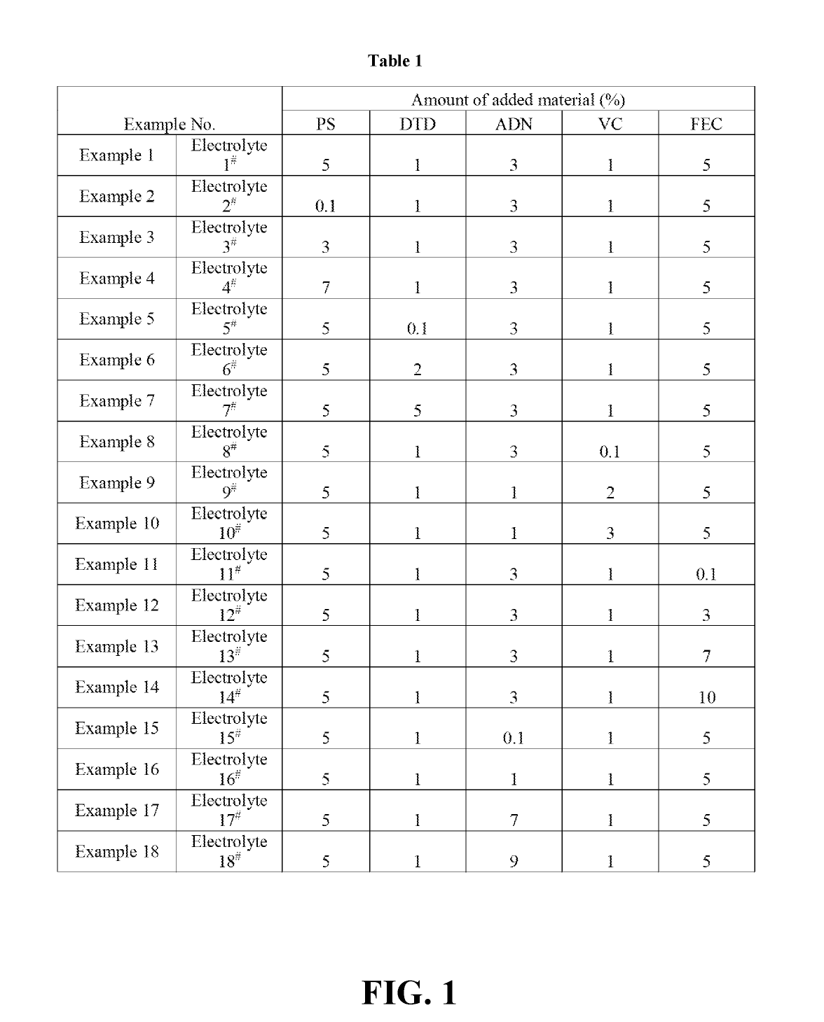

FIG. 1 is a diagram illustrating Table 1 that lists amounts of different materials added for electrolytes in Examples 1 to 18. The percent in Table 1 is a percent by weight calculated based on a ratio of the amount of an added material to the total weight of the electrolyte.

### Comparison Examples 1 to 7

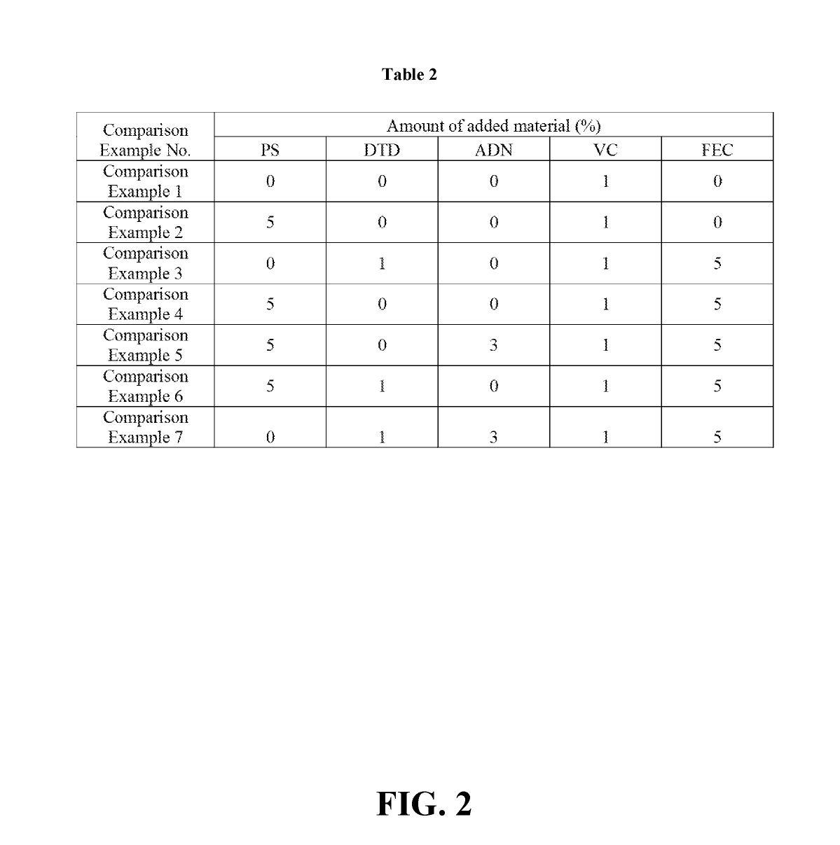

Electrolytes 1 to 7 are obtained sequentially in Comparison Examples 1 to 7 according to the preparation method described above for Examples 1 to 18. FIG. 2 is a diagram illustrating Table 2 that lists amounts of different materials added for electrolytes in Comparison Examples 1 to 7. The percent in Table 2 is a percent by weight calculated based on a ratio of the amount of an added material to the total weight of the electrolyte.

### EXPERIMENT EXAMPLES

Preparation of Lithium-Ion Batteries

Electrolytes 1¹⁹⁰ to 18# and Electrolytes 1 to 7 obtained sequentially in the Examples and Comparison Examples are used to prepare sequentially Lithium-ion batteries 1¹⁹⁰ to 18^{#} and Lithium-ion batteries 1 to 7, respectively, according to the following steps:

(1) Preparation of a Positive Film

Mix lithium cobalt oxide (LiCoO₂), a bonding agent (PVDF), and a conductive agent (carbon nanotube) at a ratio by weight of 98:1:1, add N-Methylpyrrolidone (NMP), stir with a vacuum stirrer until the system becomes homogeneous and clear, thereby obtaining a positive electrode paste; evenly spread the positive electrode paste onto a 12 μm thick aluminum foil; dry the aluminum foil in the air at room temperature, transfer into a 120° C. oven to dry for 1 h, and then obtain a positive film after cold-pressing and cutting.

(2) Preparation of a Negative Film

Mix graphite, a bonding agent (SBR emulsion), and a conductive agent (carbon nanotube) at a ratio by weight of 98:1:1, add into deionized water, stir with a vacuum stirrer to obtain a negative electrode paste; evenly spread the negative electrode paste onto a 8 μm thick copper foil; dry the copper foil in the air at room temperature, transfer into a 120° C. oven to dry for 1 h, and then obtain a negative film after cold-pressing and cutting.

(3) Preparation of a Lithium-Ion Battery

Wind the positive film, the negative film, and the separator, pack with an aluminum laminated film, inject an electrolyte, seal the opening, and obtain a lithium-ion battery after the steps of placing undisturbed, hot and cold pressing, formation, holding, grading, etc.

Performance Tests

(1) Test of Storage Performance at 60° C.

Subject Lithium-ion batteries 1^{#} to 18^{#} and Lithium-ion batteries 1 to 7 to the following test, respectively:

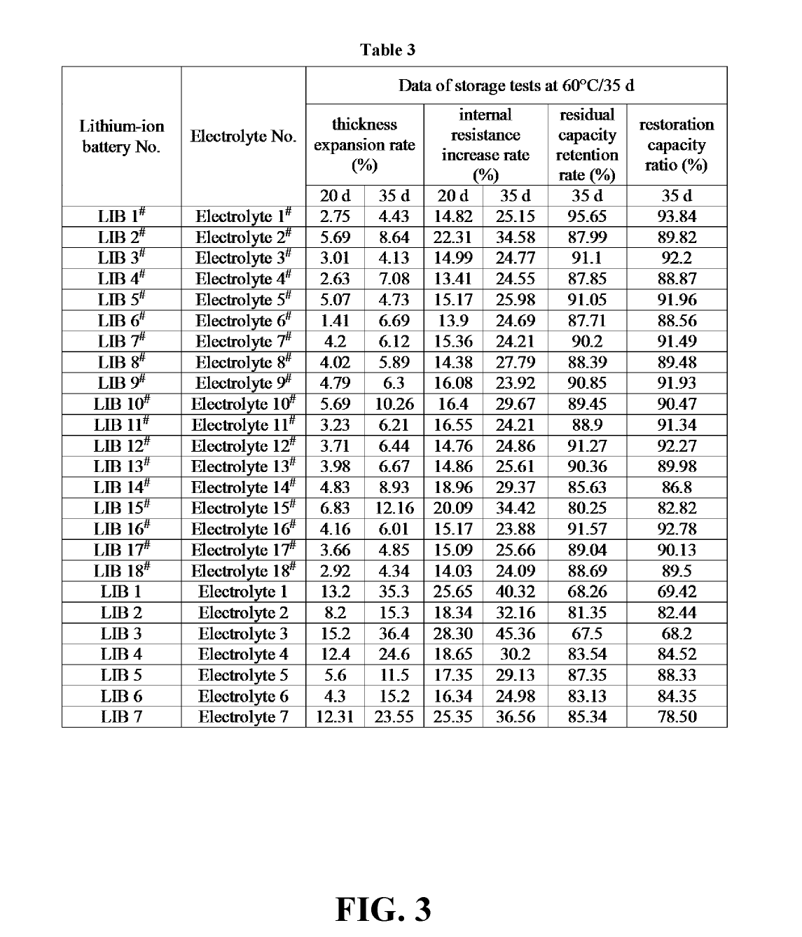

Charge the lithium-ion batteries to 4.4 V at a constant current of 0.5 C (C-rate), then charge at a constant voltage of 4.4 V until the current is below 0.05 C, stop charging, place at 60° C. for 35 d, when the storage ends, discharge at 0.5 C to 3.0 V, and obtain the residual capacity after storage; charge again to 4.4 V at a constant current of 0.5 C, then charge at a constant voltage of 4.4 V until the current is below 0.05 C, stop charging, subsequently discharge at 0.5 C to 3.0 V, and use the obtained capacity as the restoration capacity after storage. FIG. 3 is a diagram illustrating Table 3 that lists electrolytes used in different lithium-ion batteries, as well as measured thickness expansion rate and internal resistance increase rate at 20 d and 35 d, and residual capacity retention rate and restoration capacity ratio at 35 d of each lithium-ion battery.

Wherein, residual capacity retention rate=(residual capacity after storage/discharge capacity in the initial cycle)×100%; restoration capacity ratio=(restoration capacity after storage/discharge capacity in the initial cycle)×100%; thickness expansion rate=[(thickness after storage−thickness before storage)/thickness before storage]×100%; internal resistance increase rate=[(internal resistance after storage−internal resistance before storage)/internal resistance before storage]×100%.

It can be seen from Table 3 that, relative to the thickness expansion rate and internal resistance increase rate detected for Lithium-ion batteries 1^{#} to 18¹⁹⁰ , the thickness expansion rate and internal resistance increase rate of Lithium-ion batteries 1 to 7 increase somewhat as a whole, while relative to the residual capacity retention rate and restoration capacity ratio detected for Lithium-ion batteries 1^{#} to 18^{#}, the residual capacity retention rate and restoration capacity ratio of Lithium-ion batteries 1 to 7 decrease significantly.

Therefore, it can be seen that the use of the electrolyte according to the present disclosure in a lithium-ion battery can improve high-temperature storage performance of the lithium-ion battery at a high voltage.

(2) Test of Initial Efficiency and Storage Performance at 45° C.

Subject Lithium-ion batteries 1^{#} to 18^{#} and Lithium-ion batteries 1 to 7 to the following test, respectively:

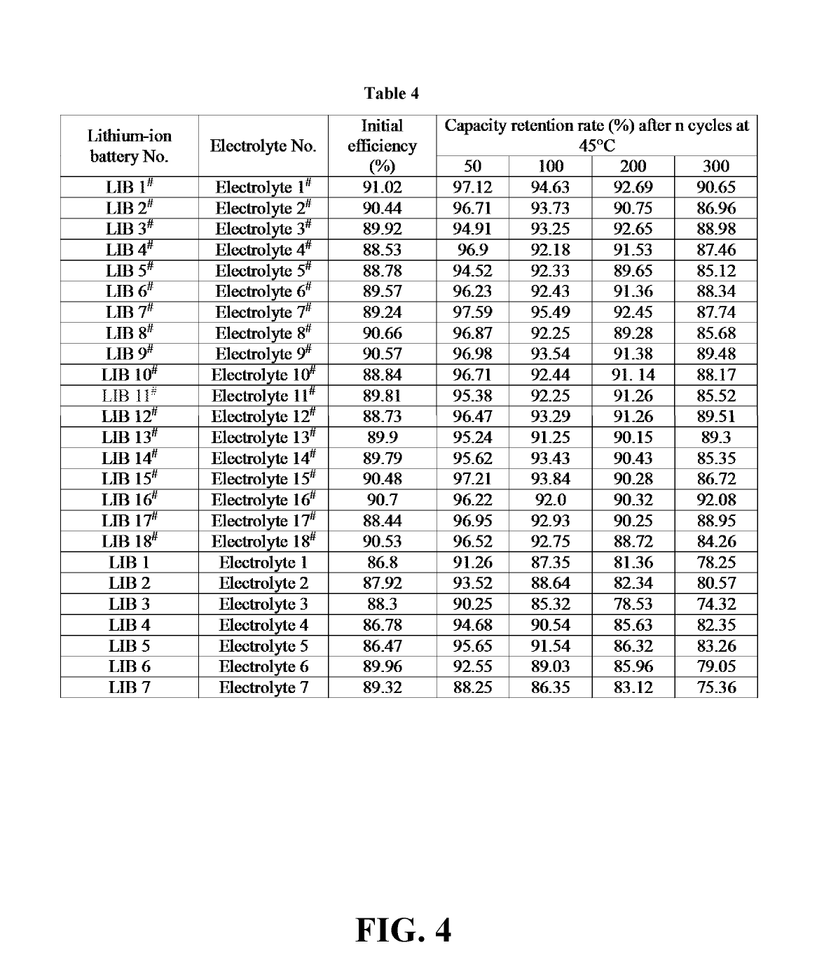

At 45° C., charge the lithium-ion batteries to 4.4 V at a constant current of 0.5 C, then charge at a constant voltage until the current is 0.05 C, discharge at a constant current of 0.5 C to 3.0 V, and measure to obtain initial efficiency. In addition, following the cycle conditions of charging/discharging described above, measure capacity retention rate after lithium-ion batteries have gone through 50, 100, 200, and 300 cycles. FIG. 4 is a diagram illustrating Table 4 that lists electrolytes used in different lithium-ion batteries and the test results of initial efficiency and storage performance at 45° C. of each lithium-ion battery.

Wherein, initial efficiency=(initial discharge capacity/initial charge capacity)×100%, and capacity retention rate after cycles=(discharge capacity after a corresponding number of cycles/initial discharge capacity)×100%.

It can be seen from Table 4 that, relative to the initial efficiency detected for Lithium-ion batteries 1^{#} to 18^{#}, the initial efficiency of Lithium-ion batteries 1 to 7 all decreases somewhat as a whole, while relative to the capacity retention rate detected after 50, 100, 200 and 300 cycles for Lithium-ion batteries 1^{#} to 18^{#}, the capacity retention rate detected after 50, 100, 200 and 300 cycles for Lithium-ion batteries 1 to 7 all decreases significantly.

Therefore, it can be seen that the use of the electrolyte according to the present disclosure in a lithium-ion battery can improve initial efficiency and cycle performance of the lithium-ion battery at a high voltage.

(3) Test of Overcharge Resistance Performance

Subject Lithium-ion batteries 1^{#} to 18^{#} and Lithium-ion batteries 1 to 7 to the following test, respectively:

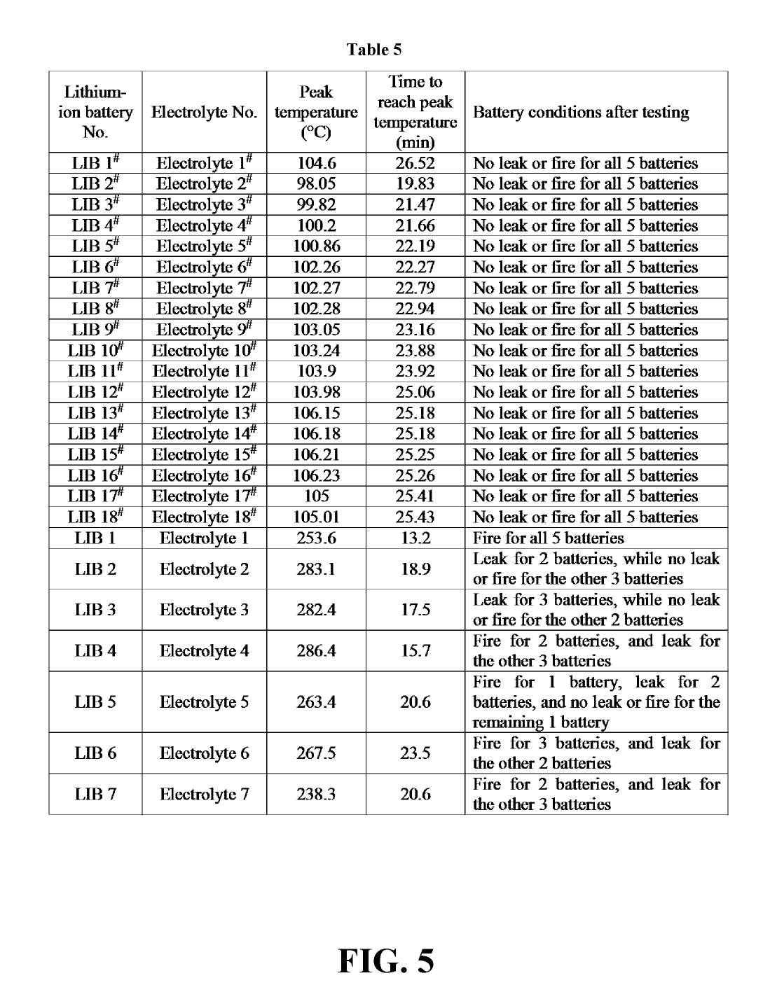

At 25° C., prepare 5 identical lithium-ion batteries, begin to charge all 5 batteries at a constant current of 1 C and a constant voltage of 10 V, until they are overcharged, and at the same time, measure peak temperatures of the lithium-ion batteries and time to reach the peak temperatures, and determine the average thereof. When the batteries are charged to 4.4 V, a timer is started to run to measure the time to reach the peak temperatures while the peak temperatures are being detected, and at the same time, conditions of the overcharged lithium-ion batteries are observed and summarized. FIG. 5 is a diagram illustrating Table 5 that lists electrolytes used in different lithium-ion batteries and the test results of overcharging endurance performance of each lithium-ion battery.

It can be seen from Table 5 that, relative to the peak temperatures detected for

Lithium-ion batteries 1^{#} to 18^{#}, the peak temperatures of Lithium-ion batteries 1 to 7 all increase significantly, while relative to the time to reach the peak temperatures used by Lithium-ion batteries 1^{#} to 18^{#}, the time to reach the peak temperatures by Lithium-ion batteries 1 to 7 shortens significantly. In addition, relative to the observation of relevant conditions of Lithium-ion batteries 1^{#} to 18^{#}, Lithium-ion batteries 1 to 7 all have leak and/or fire to various degrees.

Therefore, it can be seen that the use of the electrolyte according to the present disclosure in a lithium-ion battery can improve overcharging endurance performance of the lithium-ion battery at a high voltage and significantly improves safety performance of the lithium-ion battery at a high voltage.

(5) Determination of SEI Film Resistance and Charge Transfer Resistance

Subject Lithium-ion batteries 1^{#} to 18^{#} and Lithium-ion batteries 1 to 7 to the following test, respectively:

At 45° C., charge the lithium-ion batteries to 4.4 V at a constant current of 0.5 C, then charge at a constant voltage until the current is 0.05 C, discharge at a constant current of 0.5 C to 3.85 V, and then use a German Zahner IM6ex electrochemistry workstation to perform Electrochemical Impedance Spectroscopy (EIS) test on the lithium-ion batteries that have been discharged to 3.85 V, obtain film resistance Rf and charge transfer resistance Rct, wherein values of film resistance Rf and charge transfer resistance Rct reflect the thickness of a SEI film. It should be noted that, the higher the film resistance Rf and charge transfer resistance Rct are, the thicker a SEI film is; the lower the film resistance Rf and charge transfer resistance Rct are, the thinner a SEI film is, and vice versa. In other words, the thicker a SEI film is, the higher the film resistance Rf and charge transfer resistance Rct are; and the thinner a SEI film is, the lower the film resistance Rf and charge transfer resistance Rct are.

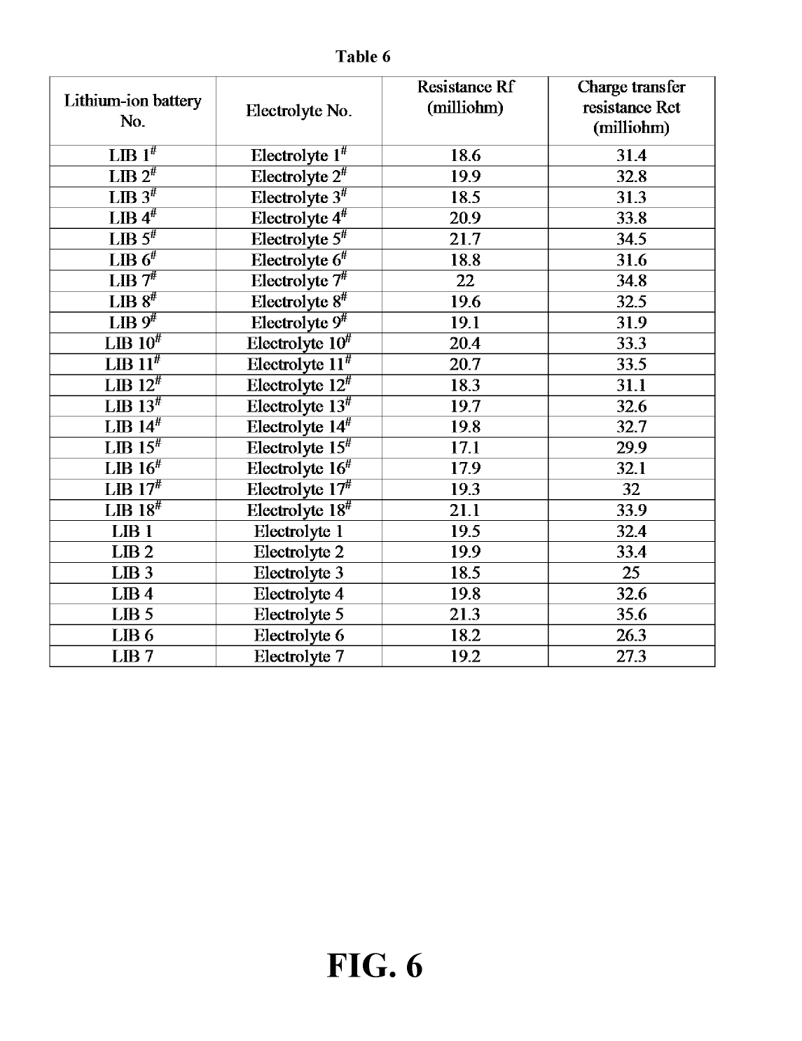

FIG. 6 is a diagram illustrating Table 6 that lists electrolytes used in different lithium-ion batteries and the test results of SEI film resistance and charge transfer resistance of each lithium-ion battery. It can be seen from Table 6 that, relative to the film resistance Rf and charge transfer resistance Rct detected for Lithium-ion batteries 1^{#} to 18^{#}, the film resistance Rf and charge transfer resistance Rct obtained for Lithium-ion batteries 1 to 7 all decrease significantly. Therefore, it can be seen that electrolytes obtained in the Comparison Examples do not form effective protective films on cathodes and anodes of the lithium-ion batteries.

Therefore, it can be seen that the use of the electrolyte according to the present disclosure in a lithium-ion battery is more effective in forming films on cathodes and anodes of lithium-ion batteries, and the formed SEI films have relatively low thickness, such that the lithium-ion battery has improved dynamics, for example, more favorable for migration of lithium-ions.

According to the disclosure and description above, those skilled in the art may further make variations and modifications to the above embodiments. Therefore, the present disclosure is not limited by the specific embodiments disclosed and described above. Some equivalent variations and modifications to the present disclosure shall also be encompassed the claims of the present disclosure. Although the Description uses some specific terms, in addition, the terms are used only for the purpose of easy description, which do not constitute any limitation to the present disclosure.

What is claimed is:

1. An electrolyte, comprising:
an organic solvent;
a lithium salt;
vinylene carbonate;
fluoroethylene carbonate; and
a combined additive, wherein said combined additive comprises:
propane sultone at 0.1% to 7% of a total weight of the electrolyte;
ethylene sulfate at 0.1% to 7% of the total weight of the electrolyte; and
adipic dinitrile at 0.1% to 9% of the total weight of the electrolyte.

2. The electrolyte of claim 1, wherein the vinylene carbonate is 0.1% to 3% of the total weight of the electrolyte, and/or the fluoroethylene carbonate is 0.1% to 10% of the total weight of the electrolyte.

3. The electrolyte of claim 1, wherein the propane sultone is 0.8% to 6.5% of the total weight of the electrolyte.

4. The electrolyte of claim 1, wherein the ethylene sulfate is 0.3% to 5.5% of the total weight of the electrolyte.

5. The electrolyte of claim 1, wherein the adipic dinitrile is 0.4% to 8.5% of the total weight of the electrolyte.

6. The electrolyte of claim 1, wherein the lithium salt is one or more substances selected from the group consisting of lithium hexafluoro phosphate, lithium tetrafluoro borate, lithium hexafluoro arsenate, lithium perchlorate, trifluoro sulphonyl lithium, lithium bis(trifluoromethanesulphonyl)imide, lithium bis(fluorosulphonyl)imide, and lithium tris(trifluoromethanesulphonyl)methide.

7. The electrolyte of claim 1, wherein a content of the lithium salt in the electrolyte is such that a molarity of the lithium salt in the electrolyte is 0.7 to 1.3 mol/L.

8. The electrolyte of claim 1, wherein the organic solvent is one or more substances selected from the group consisting of ethylene carbonate, propene carbonate, dimethyl carbonate, diethyl carbonate, ethylmethyl carbonate, γ-butyrolactone, methyl formate, ethyl formate, ethyl propionate, and tetrahydrofuran.

9. A lithium-ion battery, comprising:
a positive film;
a negative film;
a separator for the lithium-ion battery; and
an electrolyte comprising:
an organic solvent;
a lithium salt;
vinylene carbonate;
fluoroethylene carbonate; and
a combined additive, wherein said combined additive comprises:
propane sultone at 0.1% to 7% of a total weight of the electrolyte;
ethylene sulfate at 0.1% to 7% of the total weight of the electrolyte; and
adipic dinitrile at 0.1% to 9% of the total weight of the electrolyte.

10. The lithium-ion battery of claim 9, wherein the positive film comprises a positive electrode current collector and a positive electrode active substance layer disposed on the positive electrode current collector, said positive electrode active substance layer comprising a positive electrode active material, a first bonding agent, and a first conductive agent, said negative film comprising a negative electrode current collector and a negative electrode active substance layer disposed on the negative electrode current collector, and said negative electrode active substance layer comprising a negative electrode active material, a second bonding agent, and a second conductive agent.

11. The lithium-ion battery of claim 10, wherein the positive electrode active material is one or more substances selected from the group consisting of LiCoO₂, LiMn₂O₄, and Li (CoₓNi_{y}Mn_{1-x-y})O₂, wherein 0.3≦x≦0.8, 0.1≦y≦0.4, and 0.6≦x+y≦0. 9, wherein the negative electrode active material is one or more substances selected from the group consisting of graphite and silicon.

12. The lithium-ion battery of claim 9, wherein the vinylene carbonate is 0.1% to 3% of the total weight of the electrolyte, and/or the fluoroethylene carbonate is 0.1% to 10% of the total weight of the electrolyte.

13. The lithium-ion battery of claim 9, wherein the propane sultone is 0.8% to 6.5% of the total weight of the electrolyte.

14. The lithium-ion battery of claim 9, wherein the ethylene sulfate is 0.3% to 5.5% of the total weight of the electrolyte.

15. The lithium-ion battery of claim 9, wherein the adipic dinitrile is 0.4% to 8.5% of the total weight of the electrolyte.

16. The lithium-ion battery of claim 9, wherein the lithium salt is one or more substances selected from the group consisting of lithium hexafluoro phosphate, lithium tetrafluoro borate, lithium hexafluoro arsenate, lithium perchlorate, trifluoro sulphonyl lithium, lithium bis(trifluoromethanesulphonyl)imide, lithium bis(fluorosulphonyl)imide, and lithium tris(trifluoromethanesulphonyl)methide.

17. The lithium-ion battery of claim 9, wherein a content of the lithium salt in the electrolyte is such that a molarity of the lithium salt in the electrolyte is 0.7 to 1.3 mol/L.

18. The lithium-ion battery of claim 9, wherein the organic solvent is one or more substances selected from the group consisting of ethylene carbonate, propene carbonate, dimethyl carbonate, diethyl carbonate, ethylmethyl carbonate, γ-butyrolactone, methyl formate, ethyl formate, ethyl propionate, and tetrahydrofuran.
